(19) United States
(12) Patent Application Publication
(10) Pub. No.: US 2016/0000056 A1
(43) Pub. Date: Jan. 7, 2016

(54) Fishing Decoy for Marine Vessels

(71) Applicants: MARLAN HOFFMAN, San Diego, CA (US); MARK HOFFMAN, San Diego, CA (US)

(72) Inventors: MARLAN HOFFMAN, San Diego, CA (US); MARK HOFFMAN, San Diego, CA (US)

(21) Appl. No.: 14/324,132

(22) Filed: Jul. 4, 2014

(51) Int. Cl. A01K 85/00; A01M 31/06; B63B 35/14; A01K 85/01

(52) U.S. Cl. CPC A01K 85/005; A01K 85/01; A01M 31/06; B63B 35/14

(57) ABSTRACT

The present invention includes an array of fish-shaped reflective elements, or fish decoys, which may be formed with an adhesive backing which facilitates the attachment of the reflective elements to the underside, or hull, of a vessel, such as a fishing vessel. The fish-shaped reflective elements may be configured on the hull in a pattern corresponding to the natural schooling of the prey for the fish being sought. The reflective elements may vary in size depending on the fish species being mimicked.

### FIELD OF THE INVENTION

The present invention relates generally to marine vessels, and more particularly to vessels used for fishing. The present invention is useful for attracting fish to a vessel in order to facilitate more successful angling.

### BACKGROUND OF THE INVENTION

Fishing is simply the activity of trying to catch fish. Fish are normally caught in the wild and the techniques for catching them include hand gathering, spearing, netting, trapping, and angling. In addition to providing food, modern fishing is also a recreational pastime. Indeed, fishing is a favorite pastime that appeals to the relaxed coastal angler as well as to the more serious fisherman in pursuit of the largest of gamefish.

Coastal epipelagic fish are among the most abundant in the world. They can be broadly divided into small forage fish and the larger predator fish which feed on them. Forage fish most often filter feed on plankton and are relatively small, usually less than 10 centimeters long. They often remain in schools and some species may migrate large distances between spawning grounds and feeding grounds. Small pelagic fish, such as herring, sardines, and anchovy are usually forage fish that are hunted by larger pelagic fish and other predators.

In general, predatory and forage fish share the same physical features which include large mouths, smooth bodies, and deeply forked tails. Many use vision to locate plankton or smaller fish upon which to feed. Both predators and their smaller prey fish are usually shaded with a variety of silvery colors. For instance, anchovies are small, green fish with blue reflections due to a silver longitudinal stripe that runs from the base of the caudal fin. They typically range from one to sixteen inches in adult length, and the body shape is variable, with more slender fish in northern populations.

Epipelagic fish have hard protective scales on their skin for protection, and many species of fish have silvery color scales which reflect light. In some cases, this reflection serves as a camouflage, while in other cases the reflection allows predators to view them more easily. In either case, fish are often drawn to reflective objects in order to seek the safety of a school, or the abundant food source a school might provide.

It is also known that epipelagic fish are fascinated with floating objects. They aggregate in considerable numbers around objects such as drifting flotsam, rafts, jellyfish and floating seaweed. The objects appear to provide an anomaly in the otherwise open sea and can offer some protection for juvenile fish from predators. For instance, coastal juvenile fish may use drifting seaweed, commonly known as kelp patties, for the shelter and the food that is available from invertebrates and other fish associated with it. In fact, the availability of drifting seaweed or jellyfish can result in significant increases in the survival rates of some juvenile species. Also, epipelagic fish can also feed on squid, crab and jelly fish, and as result, often congregate near collections of such prey.

Fish species that travel large distances, such as tuna, can be captured by tracking these fish in large fishing vessels. A simple alternative is to utilize the fascination these fish have with floating objects. When fishermen use such objects, they are called fish aggregating devices (FADs). FADs are anchored rafts or objects of any type, floating on the surface or just below it. Fishermen often set up floating FADs, assembled from all sorts of debris, around tropical islands, to attract fish.

Despite the tendency of epipelagic fish to gather around FADs, and the natural tendency of these same fish to be attracted to other fish having reflective scales, it is often difficult to manage a single FAD, or to set out a sufficient number of FADs to develop a significant fish population beneath them. Moreover, since many FADs are floating freely in the oceans currents, it is often difficult to track their whereabouts over time.

In light of the above, it would be advantageous to provide anglers with a fish aggregating device which would facilitate the aggregation of prey fish in order to attract specific target fish. It would be further advantageous to provide anglers with a versatile fish aggregating device that would be easy to deploy and not require any appreciable maintenance or tracking. It would be further advantageous to provide a fish aggregation device to attract predator fish, such as tuna, billfish, and shark. It would also be advantageous to provide a fish aggregation device which is easy to use, easy to maintain, and comparatively cost effective.

### SUMMARY OF THE INVENTION

The present invention includes an array of fish-shaped reflective elements, or fish decoys, which may be formed with an adhesive backing which facilitates the attachment of the reflective elements to the underside, or hull, of a vessel, such as a fishing vessel. The fish-shaped reflective elements may be configured on the hull in a pattern corresponding to the natural schooling of the prey for the fish being sought. For instance, when seeking fish which prey upon sardines, the fish-shaped reflective elements may be shaped like forage fish, such as sardines, and the reflective elements may be positioned on the hull in a configuration resembling a sardine school, or bait ball.

The reflective elements may vary in size depending on the fish species being mimicked. For instance, when seeking predator fish which preys on sardines, the reflective elements may be sized to correspond to typical sardine, such as 4 to 6 inches. Alternatively, when seeking predator fish which prey on larger fish, such as mackerel or tuna, the reflective elements may be sized to correspond to a typical mackerel, such as 8 to 16 inches in length, or a typical albacore tuna, such as 24 to 36 inches in length. In an alternative embodiment, reflective elements may also resemble squid, crab or jelly fish, allowing the angler to more specifically target different fish species.

### BRIEF DESCRIPTION OF THE FIGURES

The nature, objects, and advantages of the present invention will become more apparent to those skilled in the art after considering the following detailed description in connection with the accompanying drawings, in which like reference numerals designate like parts throughout, and wherein:

FIG. 1 is a side view of a typical fishing vessel having a hull with a portion below the waterline, having a propeller and rudder, and equipped with the fishing decoy of the present invention;

FIG. 2 is a bottom view of the typical fishing vessel of FIG. 1, showing the hull portion below the waterline, having a propeller and rudder, and equipped with the fishing decoy of the present invention that are configured in two primary groupings simulating schooling fish traveling in a clockwise circular fashion, and a random fishing decoy apart from the simulated schools;

FIG. 3 is a plan view of an exemplary fishing decoy showing the generalized shape of the decoy to resemble a prey fish, and having a body with tail fins, and may include a dorsal or pectoral fins depending on the prey fish being mimicked;

FIG. 4A is a cross-sectional view of the exemplary fishing decoy of FIG. 3, showing various layers including a base having a reflective surface, and an adhesive layer covered with a removable backing;

FIG. 4B is a cross-sectional view of another exemplary fishing decoy of FIG. 3, and includes a base having a reflective surface, and an adhesive layer covered with a removable backing and may also include reflective particles, an adhesive layer on the base layer and covered by a removable peel-off covering, and a clear sealing layer on the base layer opposite the adhesive layer to provide a barrier to the harmful sea environment;

FIG. 5 is an article of manufacture of the exemplary fishing decoys of the present invention showing a backing sheet having a number of fishing decoys positioned adjacent each other to maximize the number of fishing decoys on the sheet, and with the fishing decoys formed with a variety of shapes to resemble the varieties of the fish being mimicked in the present invention;

FIG. 6 is a side view of a typical fishing vessel having a hull with a portion below the waterline, having a propeller and rudder, and equipped with the fishing decoy of the present invention including jelly fish and squid in patterns replicating the natural congregation of the jelly fish and squid as they appear in nature;

FIG. 7 is a bottom view of the typical fishing vessel of FIG. 6, showing the hull portion below the waterline, having a propeller and rudder, and equipped with the fishing decoy of the present invention that resemble jelly fish configured in two primary groupings simulating jelly fish in a group, and a random positioning of the jelly fish apart from the simulated schools;

FIG. 8 is bottom view of the typical fishing vessel of FIG. 6, showing the hull portion below the waterline, having a propeller and rudder, and equipped with the fishing decoy of the present invention that resemble squid configured in two primary groupings simulating squid in a group, and a random positioning of the squid apart from the simulated schools; and

FIG. 9 is a bottom view of the typical fishing vessel of FIG. 6, showing the hull portion below the waterline, having a propeller and rudder, and equipped with the fishing decoy of the present invention that resemble crab configured in two primary groupings simulating crab in a group, and a random positioning of the crab apart from the grouping.

### DETAILED DESCRIPTION

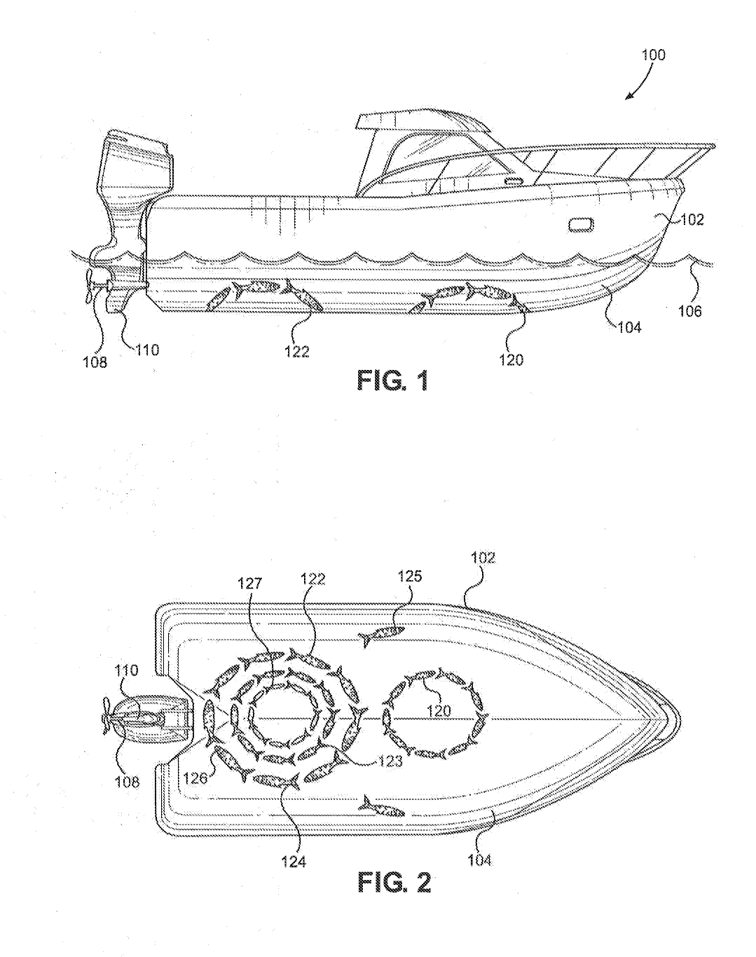

Referring now to FIG. 1, a side view of a typical fishing vessel 100 having a hull 102 with a portion 104 below the waterline 106 is shown. Vessel 100 includes, for example, a propeller 108 and rudder 110, and is equipped with the fishing decoy of the present invention as shown in decoy schools 120 and 122. From this view, the positioning of decoy schools 120 and 122 can be appreciated as covering a significant portion of the hull portion 104 below the waterline 106.

Referring to FIG. 2, a bottom view of the typical fishing vessel 100 of FIG. 1 is shown with the hull portion 104 below the waterline 106. The fishing decoy 120 and 122 of the present invention are configured in two primary groupings simulating schooling fish traveling in a clockwise circular fashion, and a random fishing decoy apart from the simulated schools. More specifically, school 120 appears as a single circular pattern of fish decoys. Alternatively, school 122 appears as a series of concentric patterns of decoys from the largest circular school 122 of decoys having multiple fish decoys 124 and 126, to concentric circular rows 123 and 127 depicting a larger school of fish. In addition to organized schools of decoys 120 and 122, random fish decoys can be positioned about submerged hull surface 104, such as fish decoy 125.

While schools 120 and 122, and singular fish decoy 125 have been shown and discussed in conjunction with the present invention, it is to be appreciated that the particular patterns shown in FIGS. 1 and 2 are merely exemplary of a preferred embodiment of the invention, and are in no way considered to limit the scope of the invention, or otherwise limit the deployment of the present invention.

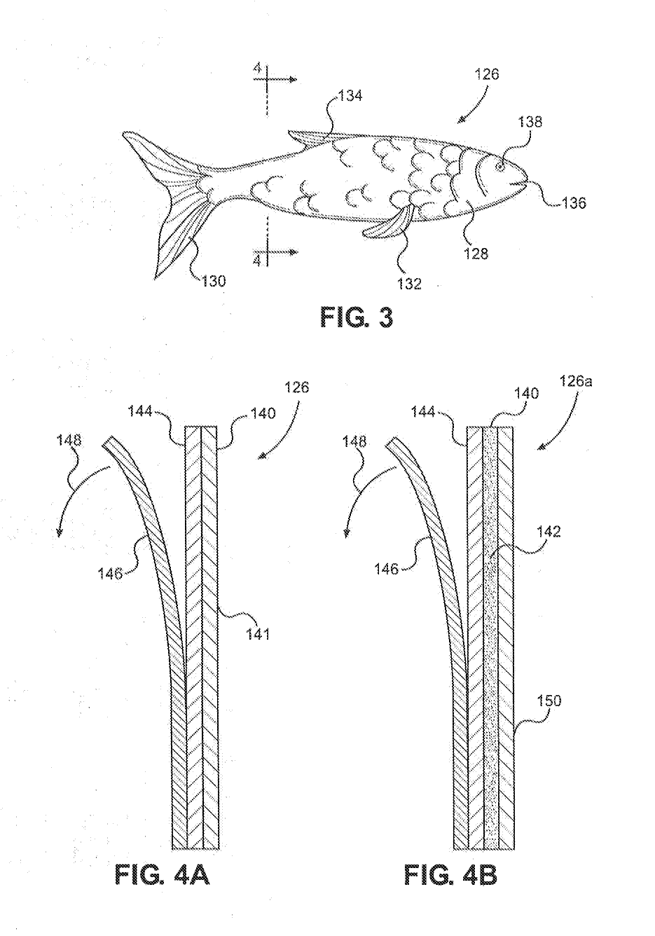

Referring now to FIG. 3, a plan view of an exemplary fishing decoy 126 is shown which provides the generalized shape of the decoy to resemble a prey fish. For example, decoy 126 is formed to have a body 128 with tail fins 130, and may include a dorsal fin 134 or pectoral fins 132 depending on the prey fish being mimicked. Also, decoy 126 may include a mouth 136 and an eye 138, From this figure, it is to be appreciated that there are many physical features which may be included in the fishing decoy 126 of the present invention. Depending on the size of the decoy, finer features, such as eyes, mouth, and pectoral fins may be omitted, such as when the decoy resembles a smaller prey fish, such as a sardine or anchovy. Moreover, as the size of the fish decoy 126 decreases, the need to accurately reflect the features of the decoy diminish as the predatory fish would be drawn to the general reflective shape rather than the specific details of the decoy 126.

Referring to FIG. 4A, a cross-sectional view of an exemplary fishing decoy 126 of FIG. 3 is shown. From this cross-sectional view, the various layers of the decoy 126 are shown. Decoy 126 includes a base layer 140 which in a preferred embodiment is reflective, such as reflective silver, on surface 141. An adhesive layer 144 is adjacent to base layer 140 and may be covered by a removable peel-off covering layer 146 which may be easily removed by pulling covering layer 146 in direction 148.

Referring to FIG. 4B, a cross-sectional view of an exemplary fishing decoy 126A of FIG. 3 is shown. From this cross-sectional view, the various layers of the decoy 126A are shown. Decoy 126A includes a base layer 140 which in a preferred embodiment is reflective, and may also include reflective particles 142. An adhesive layer 144 is adjacent to base layer 140 and may be covered by a removable peel-off covering layer 146 which may be easily removed by puffing covering layer 146 in direction 148. A clear sealing layer 150 may be provided on the base layer 140 opposite the adhesive layer 144 to provide a barrier to the harmful sea environment and to provide a longer period of reflectivity.

As shown in FIGS. 4A and 4B, fishing decoy 126 may incorporate multiple layers 140, 144 and 150 to accomplish the present invention. However, it is to be appreciated that the present invention may also be achieved using fewer layers, such as a reflective layer 140 and an adhesive layer 144. Moreover, the present invention may include simply a fish decoy having a reflective layer 140 which is attached to hull 102 using a separate adhesive. Also, reflective particles 142 may be separately applied to the surface of a base 140 to provide the benefits of a reflective surface 141 in combination with the reflective particles 142. Overall, the present invention is not limited to specific sizes, varieties, colors, or reflectivity of the fish decoys 126 of the present invention

In a preferred embodiment, the reflective layer is made from Mylar, which exhibits longevity in a harsh marine environment. It is to be appreciated that the particular materials from which the fish decoys 126 are made is not considered a limitation of the present invention. Indeed, any material known in the art and capable of use in a water environment and capable of being adhered to a submerged hull surface will suffice for the present invention. Examples of such materials are the seawater resistant Oracal® 351 series of metalized polyester film decals and the Oracal® 352 series of white and transparent polyester film decals. Both of these products are tested in seawater conditions that meet the DIN 50021 standard. For testing, the decals were adhered to aluminum and submerged in seawater. After 100 hours at 23 degrees C., the decals did not show any variations in look or performance. These products have a shelf life and a service life of two (2) years.

It is also to be appreciated that while the present invention as described herein includes the placement of multiple fish decoys 126 in the formation of fish schools is merely exemplary, the fish decoys 126 of the present invention may be arranged in virtually any position on hull 102. For instance, fish decoys 126 may be arranged in a schooling circular pattern, as shown, or in a common direction.

The silver reflectivity of the fish decoys 126 of the present invention is sufficient to attract similar fish to form a live school adjacent the hull surface 104. Also, the fish decoys 126 resemble the natural prey of the predator fish and are sufficient to attract the predator fish seeking to feed on the bait fish decoy. Most importantly, the presence of fish decoys 126 on hull 104 serves as a FAD being that the decoys are beneath a floating vessel 100, and the decoys resemble either schooling fish or prey fish for feeding predators. Whichever the case, the presence of the fish decoys 126 serve to increase the fish beneath a fishing vessel, and results in an increase in fish caught by the anglers on the boat.

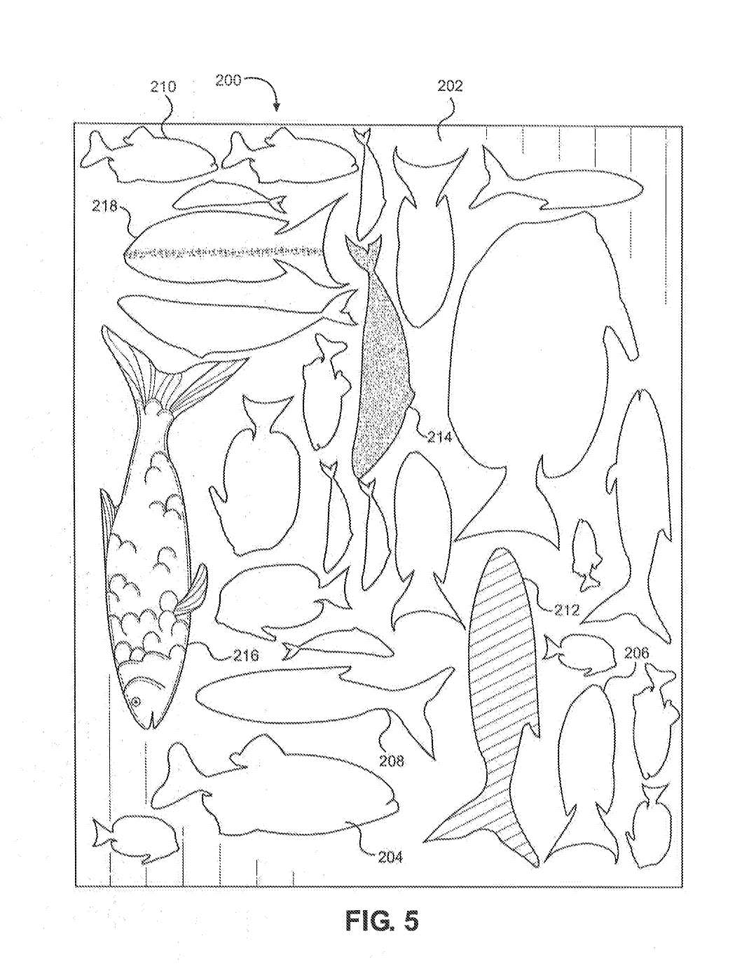

Referring now to FIG. 5, an article of manufacture of the exemplary fishing decoys 126 of the present invention is shown and generally designated 200. Article 200 includes a backing sheet 202 having a number of fishing decoys 204, 206, 208, 210, 212, 214, 216, 218, for example. These fishing decoys are positioned adjacent each other to maximize the number of fishing decoys on the sheet 202, and with the fishing decoys formed with a variety of shapes to resemble the varieties of fish being mimicked in the present invention. For instance, fishing decoys 204, 206, 208, 210, 212, 214, 216, 218 are each shown to have a different size, shape and position. Moreover, a variety of colors or reflectivity could be incorporated, such as the reflective surface of decoy 212, the particle reflectivity of decoy 214, and the stripe reflectivity of decoy 218. Also, various physical features may be shown, such as the dorsal fin, pectoral fin, mouth, and eyes, as in decoy 216.

Application of the fishing decoys of the present invention to an exemplary hull surface 104 would include, in a preferred embodiment, cleaning the hull surface to remove fouling and peeling or flaking bottom paint, and re-painting the hull surface if desired. Next, the fishing decoys of the present invention are removed from backing sheet 202 and arranged on the hull surface 104 in the desired pattern. Once adhered, the boat 100 is ready for fishing.

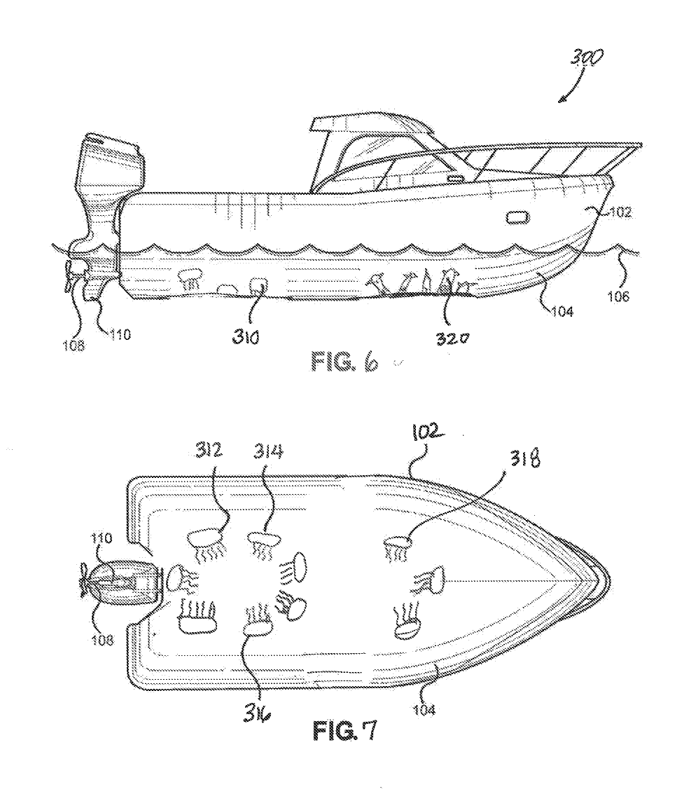

Referring now to FIG. 6, a side view of a typical fishing vessel generally designated 300 is shown having a hull 102 with a portion below the waterline 106, having a propeller 108 and rudder 110, and equipped with the fishing decoy of the present invention including jelly fish 310 and squid 320 in patterns replicating the natural congregation of the jelly fish 310 and squid 320 as they appear in nature.

FIG. 7 is a bottom view of the typical fishing vessel 300 of FIG. 6, showing the hull portion 102 below the waterline, having a propeller 108 and rudder 110, and equipped with the fishing decoy of the present invention that resemble jelly fish 312, 314, 316 configured in a primary grouping simulating jelly fish in a group, and a random positioning of the jelly fish 318 apart from the simulated schools 312, 314, 316. It is to be appreciated that a variety of patterns and configurations may be implemented without departing from the spirit of the present invention.

FIG. 8 is a bottom view of the typical fishing vessel 300 of FIG. 6, showing the hull portion 102 below the waterline, having a propeller 108 and rudder 110, and equipped with the fishing decoy of the present invention that resemble squid 322, 324, 326 configured in a primary grouping simulating squid in a group, and a random positioning of the squid 328 apart from the simulated schools 322, 324, 326. It is to be appreciated that a variety of patterns and configurations may be implemented without departing from the spirit of the present invention. and

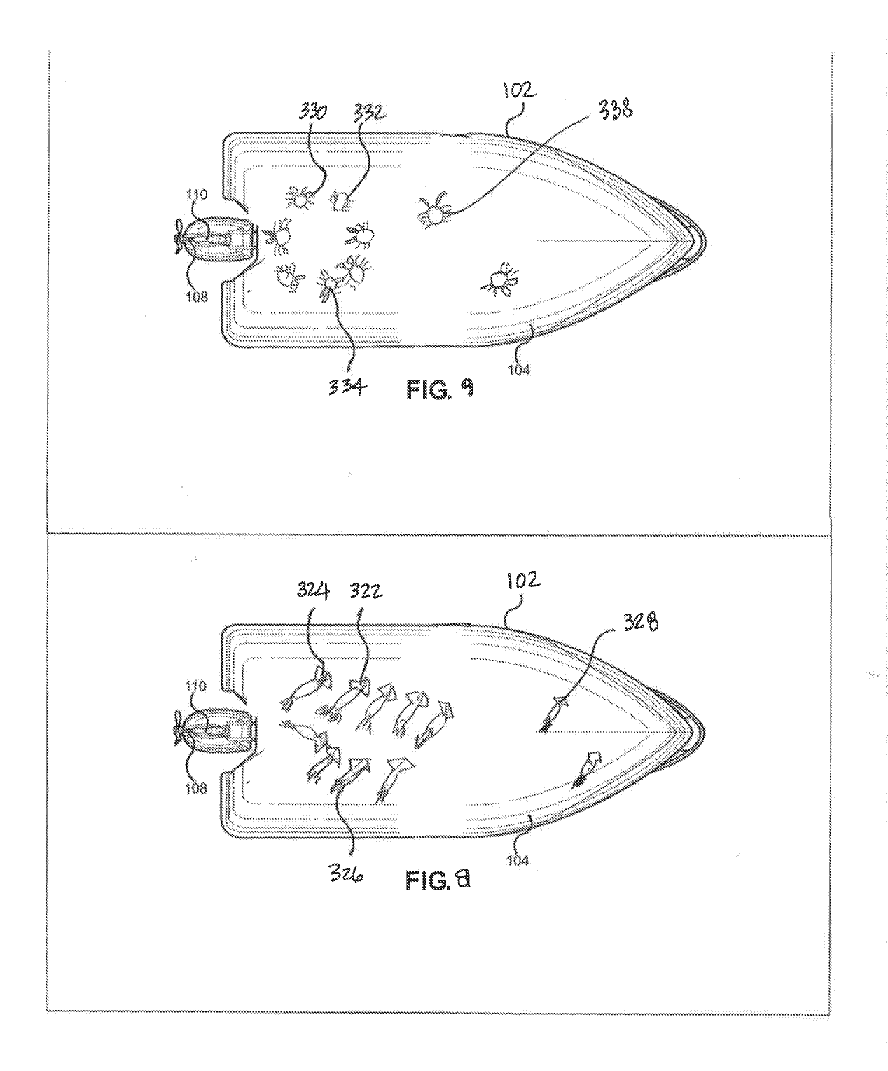

FIG. 9 is a bottom view of the typical fishing vessel 300 of FIG. 6, showing the hull portion 102 below the waterline, having a propeller 108 and rudder 110, and equipped with the fishing decoy of the present invention that resemble crab 330, 332, and 334 configured in a primary grouping simulating crab in a group, and a random positioning of the crab 338 apart from the simulated schools 330, 332, and 334. It is to be appreciated that a variety of patterns and configurations may be implemented without departing from the spirit of the present invention.

While there have been shown what are presently considered to be preferred embodiments of the present invention, it will be apparent to those skilled in the art that various changes and modifications can be made herein without departing from the scope and spirit of the invention.

What I claim is:

1. A fish aggregating device, comprising:
a plurality of fish-shaped reflective elements,
wherein the shape and color of the plurality of fish-shaped reflective elements varies to mimic different types of fish, including a body and tail fins.

2. The fish aggregating device of claim 1, further comprising an adhesive backing on the plurality of fish-shaped reflective elements.

3. The fish aggregating device of claim 1, wherein the plurality of fish-shaped reflective elements are applied to a hull of a vessel.

4. The fish aggregating device of claim 3, wherein the plurality of fish-shaped reflective elements are applied such that the elements form a decoy school of fish in a circular pattern.

5. The fish aggregating device of claim 3, wherein the plurality of fish-shaped reflective elements are applied such that the elements form a plurality of decoy schools of fish in a circular pattern.

6. The fish aggregating device of claim 3, wherein the fish-shaped reflective elements are randomly applied to the hull of the vessel.

7. The fish aggregating device of claim 3, wherein a first portion of the plurality of fish-shaped reflective elements are applied to form the shape of a bait ball and a second portion of the plurality of fish-shaped reflective elements are randomly applied to the hull.

8. The fish aggregating device of claim 3, wherein the plurality of fish-shaped reflective elements are applied such that a decoy school of fish is formed and arranged in a common direction.

9. The fish aggregating device of claim 1, wherein the fish-shaped reflective elements are further formed with a dorsal fin or a pectoral fin.

10. The fish aggregating device of claim 1, wherein the fish-shaped reflective elements are further formed with an eye and a mouth.

11. The fish aggregating device of claim 1, wherein the fish-shaped reflective elements consist of a base layer and an adhesive layer.

12. The fish aggregating device of claim 1, further consisting of a plurality of reflective particles disposed on a hull.

13. The fish aggregating device of claim 12, wherein the base layer is reflective.

14. The fish aggregating device of claim 13, wherein the base layer is made from Mylar.

15. The fish aggregating device of claim 12, wherein the base layer contains reflective particles.

16. The fish aggregating device of claim 12, wherein the fish-shaped reflective layer further consists of a clear sealing layer disposed on the base layer opposite the adhesive layer.

17. The fish aggregating device of claim 1, wherein the fish-shaped reflective elements consist of a reflective surface, particle reflectivity, or strip reflectivity.

18. The fish aggregating device of claim 1, wherein the fish-shaped reflective elements are shaped to resemble natural prey for a predator fish.

19. The fish aggregating device of claim 1, wherein the plurality of fish shaped elements are applied to form a decoy of fish in a common direction or pattern.

20. A method of applying a fish aggregating device to a hull of a vessel, comprising the steps of:
cleaning a hull surface to remove fouling and peeling or flaking bottom paint;
painting the hull surface if required;
removing fishing decoys from a backing sheet; and
applying the fishing decoys on the hull.

21. The method of applying a fish aggregating device to a hull of a vessel of claim 20, wherein the fishing decoys are applied on the hull in a desired pattern.
